(19) United States
(12) Patent Application Publication
(10) Pub. No.: US 2015/0169695 A1
(43) Pub. Date: Jun. 18, 2015

(54) LOCATION BASED EVENT IDENTIFICATION

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 14/104,627

(22) Filed: Dec. 12, 2013

(51) Int. Cl. G06F 17/30

(52) U.S. Cl. CPC G06F 17/30551; G06F 17/30342

(57) ABSTRACT

Apparatuses, methods and storage medium associated with geographic/time coordinate based event identification are disclosed herein. In embodiments, an event repository may index one or more events according to location and time of the event. The information regarding the events may be based on one or more of reports from a client device, information in static documents, or information in subscription documents. A search module coupled with the event repository may receive a query from a client device, the query including at least a time coordinate identifying a time and a location identifier identifying a location. The search module may be configured to identify, based on the time coordinate and the location identifier, an event that occurred at the location and at the time. Other embodiments may be described and/or claimed.

### TECHNICAL FIELD

The present disclosure relates to the field of data processing, in particular, to apparatuses, methods and storage medium associated with event identification.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of information through the Internet. Today, users routinely use search services, such as Google®, Bing®, Yahoo®, and so forth, to locate information. Many times, a user may search for a specific location, such as an address or an intersection, or a general location such as a city or a neighborhood. Those search results may display, for example, a map of the location, nearby businesses, or other information. However, in many cases it may be difficult or impossible for a user to identify one or more events that have occurred, are occurring, or will occur at the location.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for geographic/time coordinates based event search, in accordance with various embodiments.

FIG. 2 illustrates the geographic/time coordinates based indices of the event repository of FIG. 1 in further detail, in accordance with various embodiments.

FIG. 3 illustrates an example process for identifying information regarding an event, in accordance with various embodiments.

FIG. 4 illustrates an example process for receiving and storing information regarding an event, in accordance with various embodiments.

FIG. 5 illustrates an example organization of the geographic coordinates based indices, in accordance with various embodiments.

FIG. 6 illustrates an example process for reporting information regarding an event, in accordance with various embodiments.

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage medium associated with geographic/time coordinates based event indices are disclosed herein. In embodiments, an event repository may receive information regarding an event. The information may include the name of the event, the type of the event, the location of the event, the time of the event, or other information regarding the event. In some embodiments, the information may be received based on reports from client devices that are, will be, or have been at the location of the event. In some embodiments, the information may be received based on review of static documents such as emergency reports, news sources, permitting/licensing type reports, or other information. Based on the received information, the event repository may be configured to store information of the event in an index that is organized according to one or both of time and location of the event. In some embodiments, the location of the event may be stored or organized according to geographic coordinates such as latitude or longitude of the location, or area including the location, where the event took place, is taking place or will take place.

A search module, which may be coupled with the event repository, may receive a query from a client device. The query may be about an event that has, is, or will occur at a location at a point in time. In embodiments, the query may include a time coordinate or a range of time coordinates that includes the point in time. Additionally, the query may include a location identifier that identifies the location or an area including the location. The search module may then access the event repository and search for the event. Specifically, the search module may in some embodiments convert the location identifier to geographic coordinates of the location (e.g., latitude and longitude coordinates of the location or are area including the location), and search the event repository for an event that matches the time coordinate(s) and the geographic coordinates of the event. Upon identifying the match, the search module may return information regarding the event to the client module.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

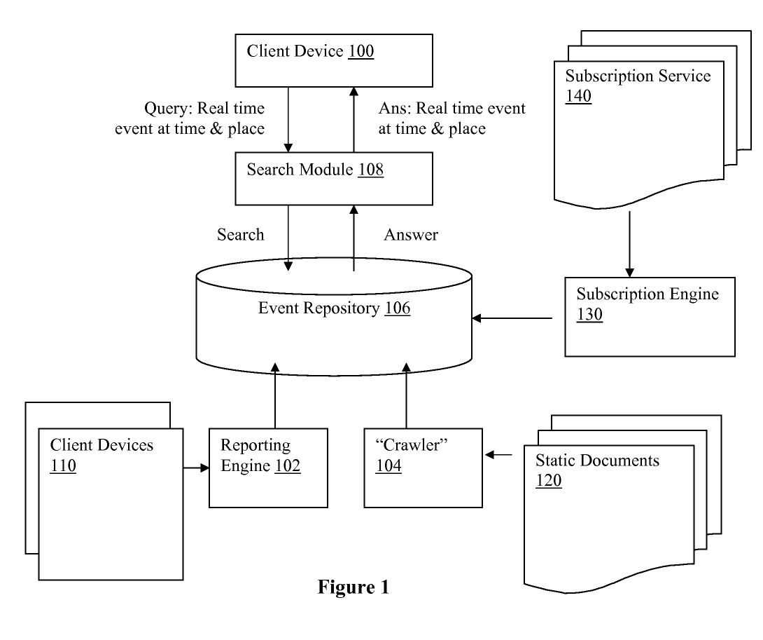

Referring now FIG. 1, wherein an arrangement for geographic/time coordinate based event search, in accordance with various embodiments, is illustrated. As shown, a client device 100 may be coupled with a search module 108. In embodiments, the client device 100 may be a device such as a personal digital assistant (PDA), smartphone, computing tablet, ultrabook, laptop computer, desktop computer, set-top box, media player, game console, and so forth. In embodiments the client device 100 may include a display and/or a user interface which the user may use to input and/or receive information.

The search module 108 may be a server which is communicatively coupled with the client device 100, or the search module 108 may be a module of the server. In embodiments, the search module 108 may be implemented as hardware, software, or firmware distributed across a plurality of servers. In embodiments, the search module 108 may be owned or operated by a search engine company such as, but not limited to, Google®, Yahoo®, Microsoft®, America Online (AOL)®, or some other company.

The search module 108 may be coupled with an event repository 106. The event repository 106, as will be explained in further detail later, may include indices related to events and may include information such as a point in time of each event, a location of each event, and/or a description of each event. In embodiments, the information related to the location of an event may include geodetic coordinates such as latitude and longitude coordinates of the location of the event. The information related to the point in time of an event may include a specific time coordinate, or a plurality of time coordinates defining a time range of the event. Specifically, the events may be organized or indexed by the latitude and longitude coordinates of the locations of the events. Additionally or alternatively, the events may be organized or indexed in the event repository 106 by the respective points in times of the events. Additionally or alternatively, the information related to the description of each event may include a name of the event and a type of the event. The type of event may include, but not limited to, types such as parades, traffic incidents, police incidents, fire incidents, emergency incidents, service calls, concerts, art shows, public gatherings, or other incidents.

While the above description describes that the events may be organized or indexed through the use geodetic coordinates that are valued in accordance with a mathematical defined reference ellipsoid that approximates the Earth, the present disclosure is not so limited. Other geographic coordinates with other geographic reference systems may also be used, including but are not limited to, e.g., geocentric coordinates that are valued in accordance with a X-Y-Z reference centered at Earth's center, or spherical coordinates that are valued based on the radial distances from Earth's center, along with polar angles measured from the zenith directions of the positions, and azimuth angles of the positions based on orthogonal projections on corresponding reference planes that pass through Earth's center and orthogonal to the zenith directions.

The information stored in the event repository 106 may be received from a plurality of sources via event reporting/acquisition modules (or simply, event modules). Three example event modules are a reporting engine 102, a “crawler” 104, and a subscription engine 130. The reporting engine 102 may be coupled (or included) with a plurality of client devices 110 which may be similar to the client device 100 described above. Specifically, the client devices 110 may be user devices that are configured to transmit reports including information related to the events to the reporting engine 102. The reports may include, for example, information such as the name of an event, a type of an event, a point in time of the event, or a location identifier of the location of the event. The client devices 110 may be configured to automatically transmit the reports to the reporting engine 102. In other embodiments, the client devices 110 may be configured to transmit the reports upon activation or direction by a user.

As an example, a client device 110 may be a mobile phone or tablet of an air conditioning service provider. When the service provider performs a service at a given location, for example repairing an air conditioning unit at that location, the client device 110 may either automatically, or at the direction of the service technician, transmit a report regarding the service to the reporting engine 102, using e.g. a client side of reporting engine 102, or a generic browser, in an embodiment where reporting engine 102 is configured to support web access. The information included in the report may include information such as the time, or time range, of the service, the type of service, the name of the technician or servicing company, and/or a location identifier of the location of the service. In embodiments the client device 110 may transmit the report to the reporting engine 102 while the client device 110 is at the location, while in other embodiments the client device 110 may transmit the report either before the client device 110 is at the location or after the client device 110 has been at the location.

Dependent upon the type of event, or the configuration of the client device 110, the location identifier may be an address of the location, geodetic coordinates of the location, a name of the location such as a business name, a neighborhood, a city, or other location information. In embodiments, the reporting engine 102 may be configured to receive the location identifier and, if the location identifier is not in geodetic coordinates, the reporting engine 102 may be configured to identify the geodetic coordinates of the specific location based on the location identifier.

For example, the reporting engine 102 may receive a location identifier from a client device 110 about an event at a location, and the location identifier may include the keyword “San Francisco.” The reporting engine 102 may determine from that keyword that the event is associated with the geodetic latitude and longitude coordinates of {37° 46′ 29.99″ −122° 25′ 5.88″}, which may be considered as the geodetic latitude and longitude coordinates of the City of San Francisco, Calif. Similarly, the reporting engine may receive a report including a location identifier having one or more of the keywords “Candlestick Park,” “Golden Gate Bridge,” “Lombard Street,” “Coit Tower,” “Castro Street,” and so forth, and determine based on these keywords that the event is associated with geodetic latitude and longitude coordinates {37° 46′ 29.99″ −122° 25′ 5.88″} of San Francisco. The reporting engine 102 may then pass the event information including the geodetic latitude and longitude coordinates and the time coordinates of the event to the event repository 106.

As noted above, the event repository 106 may further be coupled with a crawler 104. The crawler 104 may be configured to peruse one or more static documents 120 and identify event information from the static documents. In some embodiments, the crawler 104 may be configured to automatically review the one or more static documents 120, for example based on a scheduled recurring review at a given time or day, while in other embodiments the crawler 104 may be configured to review the documents at the direction of a user.

The static documents 120 may include, for example, newspapers, internet websites, police reports, fire reports, licensing reports, permitting reports, or some other type of report or document that may include information related to events. The static documents 120 may include information related to an event name, an event type, a location of the event, a time coordinate of the event, or a range of time coordinates of the event such as the event start time and end time. In some embodiments the location information in the static documents 120 may be a location identifier such as an address, a neighborhood, a city, geographic coordinates, or some other location identifier of the event. In some embodiments, one or more static documents 120 may be used to identify information about a single event. For example, the crawler 104 may identify time information and location information regarding a fire at a location from a static document 120 such as a newspaper. Alternatively, the crawler 104 may identify from a first static document 120 that a robbery occurred at a location. However, the crawler 104 may identify from a second static document 120 such as a police report information regarding the time of the robbery. In some embodiments, the crawler 104 may identify the geodetic coordinates of the event from the location information. The crawler 104 may then pass the information related to the event, including the geodetic coordinates of the event, to the event repository 106 for indexing/organizing in the index of events. In some embodiments the crawler 104 may be configured to combine the information from multiple static documents 120, while in other embodiments the event repository 106 may be configured to combine the information from the multiple static documents 120.

Additionally or alternatively, the event repository 106 may be further coupled with a subscription engine 130. The subscription engine 130 may be configured to receive event information that is transmitted to the subscription engine 130 from a subscription service 140. An example of a subscription service 140 may include subscription services offered by a messaging service feed, such as Twitter®, a rich site summary (RSS) feed, a social networking service feed, such as Facebook®, or feeds from some other type of subscription services where event information is actively pushed from the subscription service 140 to the subscription engine 130. The event information may include a description describing the event, a point in time indicating when the event took place, is taking place, or will take place, and a location identifier identifying a location or an area that includes a location denoting where the event took place, is taking place or will take place. As used herein, “pushed” may refer to the subscription service 140 actively transmitting the event information to the subscription engine 130 without a specific query or request from the subscription engine 130. For example, the subscription engine 130 may be configured to receive different feeds or pushed information from subscription services 140 from subscription services offered by internet news websites, messaging services, such as Twitter®, social networking sites, such as Facebook®, local, national, or international news organizations, emergency response services, such as police, fire, or amber alert services, or other subscription services.

As noted above, the event information received from a subscription service 140 may include, but are not limited to, information related to an event name, an event type, a location of the event, a time coordinate of the event, or a range of time coordinates of the event such as the event start time and end time. In some embodiments the location information in the event information received from a subscription service 140 may be a location identifier such as an address, a neighborhood, a city, geographic coordinates, or some other location identifier of the event. In some embodiments, event information from one or more subscription services 140 may be used to identify information about a single event, as described above with respect to the crawler 104 and static documents 120. In some embodiments, the subscription engine 130 may identify the geodetic coordinates of the event from the location information received from a subscription service 140. The subscription engine 130 may then pass the information related to the event, including the geodetic coordinates of the event, to the event repository 106 for indexing/organizing in the index of events. In some embodiments the subscription engine 130 may be configured to combine the information from multiple subscription services 140, while in other embodiments the event repository 106 may be configured to combine the information from the multiple subscription services 140.

Although the reporting engine 102, crawler 104, and subscription engine 130 are described as being configured to convert location identifiers of the event received from a client device 110, static document 120, or subscription document, respectively, to geodetic coordinates, in other embodiments the event repository 106 may be configured to identify the geodetic coordinates of an event based at least in part on other location identifiers of the event such as keywords, names, addresses, neighborhoods, cities, or other information. Additionally, in some embodiments information from a plurality of information sources may be required to acquire all of the information of the event. As an example, one static document 120 may include a name or description of the event and a location identifier, while another static document 120 or a report from a client device 110 may include the location identifier of the event and the point in time of the event. As an example, an event may be a parade in a specific neighborhood. The crawler 104 may be configured to identify, from a static document 120, the event type as a parade and the location of the event based on a location identifier such as the neighborhood. However, a client device 110 that is actually at the event may be configured to identify the start time of the event, and report that start time to the reporting engine 102. The reporting engine 102 and the crawler 104 may be configured to pass the information related to the event to the event repository 106, which may be able to combine the information from the two separate sources and create an entry for the event in the index of events in the event repository 106. In some embodiments, an event may be analyzed and stored in the event repository 106 based on a threshold. Specifically, the threshold may indicate whether information related to an event should be stored in the event repository 106 based on the importance or relevance of the event. In other words, if an event is relatively insignificant, unimportant, or irrelevant, then it may not be desirable to store the event in the event repository 106. This threshold may be based on a time of event, location of event, keywords related to the event, length of time of the event, or some other element of the event. For example, if the reporting engine 102 receives information related to an event from a client device 110, and the information includes the phrase “routine service call,” then it may not be desirable to store the “routing service call” event in the event repository.

In some embodiments, the reporting engine 102, crawler 104, or subscription engine 130 may analyze event information received from a client device 110, static document 120, and/or subscription services 140 and determine whether the event qualifies as having an importance or relevance level above the threshold. If so, then the reporting engine 102, crawler 104, or subscription engine 130 may store the received information in the event repository 106. By contrast, if the event has an importance or relevance level below the threshold, then the reporting engine 102, crawler 104, or subscription engine 130 may not store the received information in the event repository 106. This threshold may be based on rules set by an owner or operator of the event repository 106, reporting engine 102, crawler 104, or subscription engine 130.

Additionally or alternatively, a device such as the client device 110 may analyze the event based on a similar relevance or importance threshold. Specifically, the threshold may be set by an owner, operator, or user of a client device 110. If the event is identified as having a relevance or importance below the threshold, then the client device 110 may not report the information related to the event to the reporting engine 102. Similarly, the owner or operator of a subscription service 140 that pushes event information to the subscription engine 130 may analyze the event information according to an importance or relevance threshold, and not push the event information to the subscription engine 130 if the event information is below an importance or relevance threshold.

Additionally or alternatively, the event repository 106 may be configured to analyze information related to an event from different sources and identify whether the event has an importance or relevance above or below the threshold. For example, information received from the reporting engine 102 and crawler 104 may be combined and, based on the combined information, the event repository 106 may identify that the event does not satisfy the importance or relevance threshold criteria. In that case, the event repository 106 may discard the information related to the event.

In some embodiments, the threshold may be dynamic, for example changing based on the type of the event, the time of the event, the specific client device 110 or subscription service, or some other element. In other embodiments, the threshold may be static, for example events with a given keyword are always marked as below the importance threshold. Other combinations or configurations of the importance or relevance threshold may be used in other embodiments.

In operation, and as shown in FIG. 1, a client device 100 may transmit a query to the search module 108. The query may include, for example, a time coordinate, or range of time coordinates, that identifies or includes a point in time, and a location identifier of a location or an area including the location. The query may be a query regarding an event that has occurred, is occurring, or will occur at the location. The query may further include keywords or key phrases. The query may also be associated with qualifiers, e.g., Boolean and/or proximity qualifiers. The search module 108 may access the event repository 106 to identify, based at least in part on the one or more time coordinates and the location identifier, the event that has occurred, is occurring, or will occur at the location at the point in time identified by the time coordinates. In some embodiments, the location identifier may be geodetic coordinates of the location, while in other embodiments the location identifier may be an address, neighborhood, name, intersection, or city associated with the location. The search module 108 and/or the event repository 106 may then be configured to identify, based at least in part on the location identifier, the geodetic coordinates of the location as described above.

The indices of events in the event repository 106 may then be searched for one or more events matching the geodetic coordinates and the time coordinates of the location. In some cases other information such as specific event types or other criteria may be used to single out a specific event if multiple events are identified in the index of events. Information related to an event meeting the query criteria, for example the name of the event, the start/stop times of the event, the type of event, or other information of the event may then be provided to the search module 108 which in turn may provide it to the client device 100.

In embodiments, reporting engine 102, event repository 106, crawler 104, and subscription engine 130 may be implemented in any combination of hardware and/or software. In embodiments, the combination of hardware and/or software may include processor(s), memory and executable instructions implementing the functions described herein. In embodiments, in lieu of being separate elements or devices, reporting engine 102, subscription engine 130, and crawler 104 may share some common functions and/or resources. For example, reporting engine 102, subscription engine 130, and crawler 104 may share common communication functions and components for communicating with the event repository 106. As a further example, reporting engine 102, subscription engine 130, and crawler 104 may share processor and/or memory resources. In embodiments, some functions of reporting engine 102 may be moved to crawler 104, event repository 106, and/or subscription engine 130, or vice versa, or be combined. The indices of events in the event repository 106 may be implemented using any magnetic, optical, and/or solid state non-volatile storage. The magnetic, optical, and/or solid state non-volatile storage may be disposed on one platform, or coupled/networked. In embodiments, the event repository 106 may also include volatile and/or non-volatile caches.

Continuing to refer to FIG. 1, the client device 100 may be coupled with the search module 108 through any combination of private and/or public, wired and/or wireless, local and/or wide area networks. Private networks may include, e.g., but are not limited to, enterprise networks. Public networks may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that the search module 108 may be coupled with the client device 100 through one or more local area networks with gateways and firewalls, which the search module 108 would go through to communicate with a client device 100. Similarly, the client device 100 may be coupled with the search module 108 by way of one or more base stations and/or access points, through which the client device 100 may communicate with the search module 104. Further, in between the client device 100 and the search module 108 may be any number of network routers, switches and other networking equipment of the like. However, for ease of understanding, these gateways, firewalls, routers, switches, base stations, access points and the like are not shown.

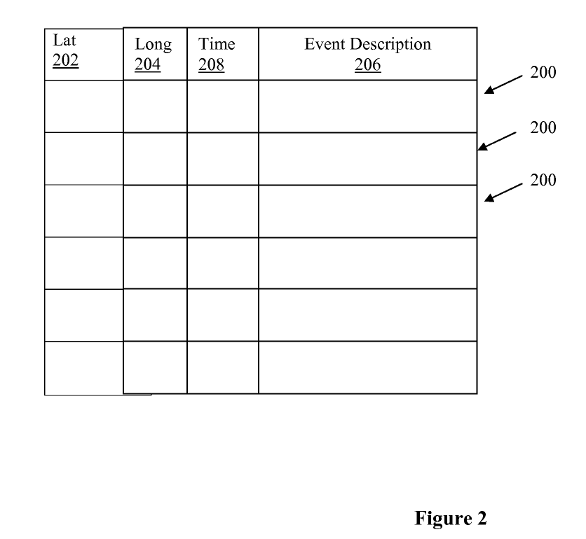

Referring now to FIG. 2, wherein the stored geographic coordinates based event indices are illustrated in further detail, in accordance with various embodiments. As shown, in embodiments, each stored entry 200 in the geographic coordinates based index may include a set of geographic coordinates of a location on Earth's surface, e.g., latitude 202 and longitude 204, a time coordinate 208, and an event description 206. The latitude 202 and longitude 204 coordinates may be coordinates of the location of the event. The event description 206 may be or include a variety of information regarding the event such as the name of the event, the type of the event, or other information regarding the event. The time coordinate 208 may be the point in time of the event or a range of time coordinates of the event specifying at least a start time and stop time of the event.

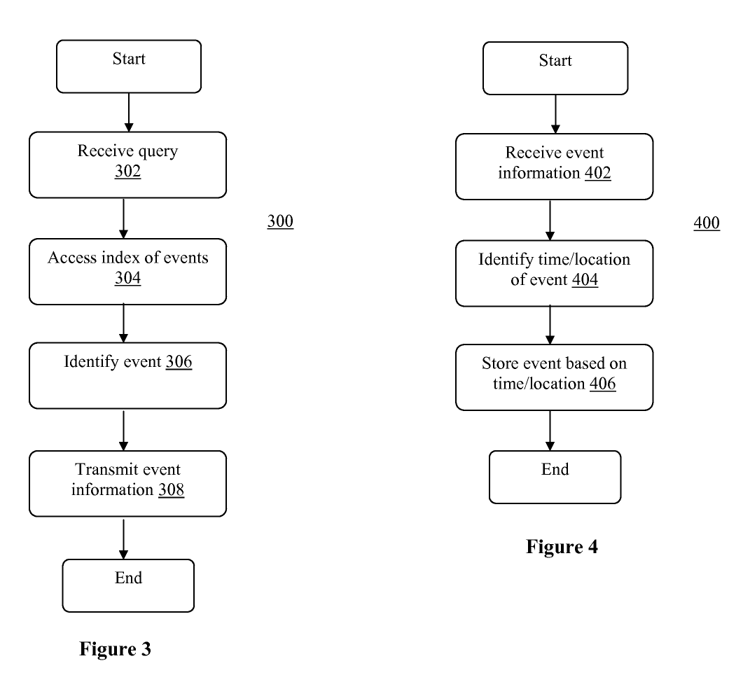

Referring now to FIG. 3, wherein an example process 300 for identifying one or more events based at least in part on a query from a client device, in accordance with various embodiments, is illustrated. As shown, process 300 may start at block 302. At block 302, a server such as a search module 108 may receive, from a client device 100, a query related to an event. The query may include, for example, information related to a time coordinate or a range of time coordinates that includes a point in time of an event. The query may also include, for example, a location identifier that identifies a location or an area including the location of the event.

At block 304, the search module 108 may access the event repository 106. Specifically, the search module 108 may either transmit the query to the event repository 106, or otherwise search the event repository 106. As noted above, the indices of events in the event repository 106 may be organized according to longitude and latitude coordinates of the event, though in other embodiments the indices of events may be organized according to alternative or additional criteria.

An event may be identified by the search module 108 at 306. Specifically, the event may be identified by the search module 108 based on a search of the indices of events using the information from the query. The search module 108 may retrieve the information related to the event and transmit the event information to the client device 100 at 308. In some embodiments, the event repository 106 may identify, based on information, received from the search module 108, the event and transmit the event information to the search module 108. The event information may be identified at 306 based at least in part on the time coordinate or coordinates and the location identifier received by the search module 108 in the query. The event information transmitted by the search module 108 at 308 may include, for example, information related to the location of the event, the time or time range of the event, the type of the event, the name of the event, or other information related to the event. The process 300 may then end.

Referring now FIG. 4, wherein an example process 400 for receiving and indexing information related to a plurality of events, in accordance with various embodiments, is illustrated. As shown, process 400 may begin at block 402. At block 402, an event repository such as the event repository 106 may receive information related to an event. Specifically, the information may be received from a reporting engine 102, a crawler 104, a subscription engine 130, or some other information source. In embodiments, the information may include information about one or more events such as where the event is, did, or will take place. Additionally or alternatively, the information may include information such as when the event is, did, or will take place. The information may include additional information such as a name of the event, a type of the event, or other information related to the event.

Based on the information received at 402, the event repository 106 may identify the time coordinates and/or the location coordinates of the event at 404. Specifically, the time coordinates may include the specific time coordinate of the event, or a range of time coordinates of the event which may include, for example, a start time and/or a stop time. The location coordinates may include, for example, latitude and longitude coordinates of the location of the event or an area of the event that includes the location.

The event repository 106 may then store the information about the event in the index of events at 406. In some embodiments, before storing the information, the event repository 106 may identify from the information about the event that the event satisfies an importance or relevance criteria, for example using an importance or relevance threshold. Based on that threshold, the event repository 106 may store the information about the event at 406. Specifically, the event repository 106 may add the event to the index of events. The event may be indexed in the index of events according to the time and/or location coordinates of the event. The process may then end.

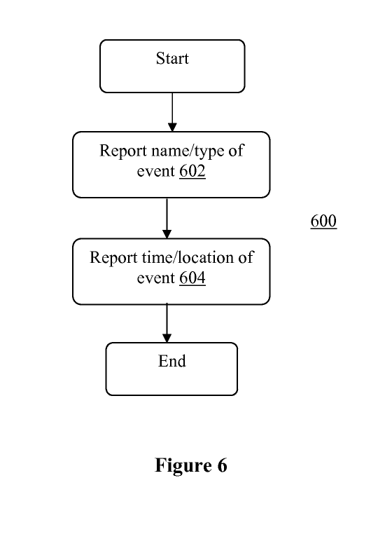

Referring now FIG. 6, wherein an example process 600 for reporting information about an event, in accordance with various embodiments, is illustrated. As shown, process 600 may begin at block 602. At 602, a client device 110, reporting engine 102, crawler 104, or a subscription engine 130 may report, to an event repository 106, information about an event such as a name or type of the event. The client device 110, reporting engine 102, crawler 104, or subscription engine 130 may then report, either sequentially or in parallel with the report at 602, a time of the event or a location identifier of the event at 604. The time of the event may include, for example, a specific time coordinate of the event or a range of time coordinates of the event which may include, for example, a start time and/or stop time of the event. The location identifier of the event may include, for example, the address of the event, the name of a location or area of the event, a latitude coordinate of the event, and/or a longitude coordinate of the event. In some embodiments, the client device 110 may report the name/type of the event at 602 and the time/location of the event at 604 to the event repository, while in other embodiments the client device 110 may report the name/type and time/location of the event to a reporting engine 102 coupled with the event repository 106. In some embodiments, prior to reporting the event information to the event repository 106, one or more of the client device 110, reporting engine 102, crawler 104, or subscription engine 130 may identify that the event satisfies an importance and/or relevance criteria, for example an importance or relevance threshold, as described above. The process may then end.

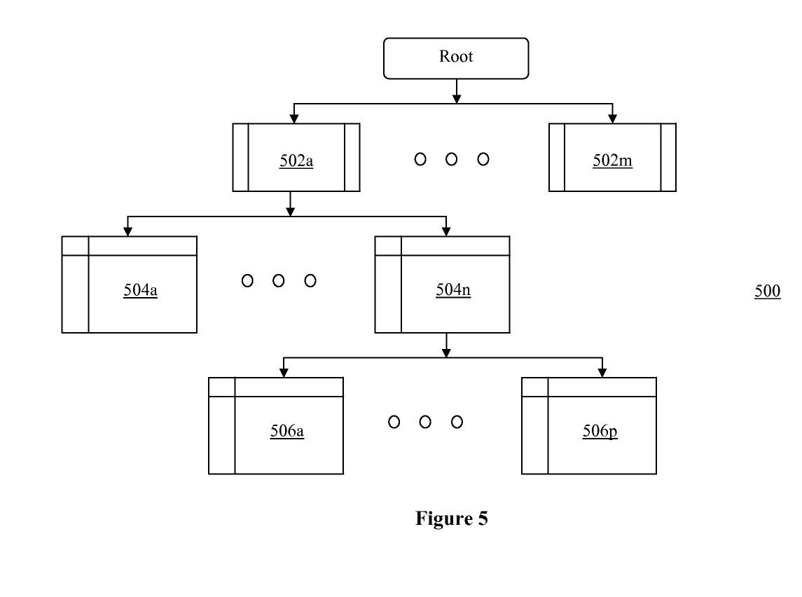

Referring now briefly back to FIG. 2, in embodiments, the time and/or location data of the events may be correspondingly stored in indices of events in the event repository 106 in any one of a number of data organizations or structures, to facilitate efficient traversal for identification of potential relevant contents. FIG. 5 illustrates an example organization of the geographic coordinates based indices, in accordance with various embodiments. Example organization 500 may be a hierarchical organization/structure having a number of organization levels, including one or more intermediate or node levels 502-504 and the lowest or leaf level 506. In embodiments, geographical coordinate based indices having geographic coordinates of various locations indexing the locations to associated events may be stored in the lowest or leaf level 506, such as 506a . . . 506p. Further, geographical coordinate based indices having geographic coordinate ranges defining areas and/or regions of various sizes indexing the areas/regions to each other and to the contents may be stored in the one or more intermediate levels 502, 504, and so forth, such as 502a . . . 502m and 504a . . . 504n.

For example, in one embodiment, the lowest level 506 may store the geographic coordinates based indices indexing cities, such as San Francisco, Los Angeles, to associated contents. A next immediate intermediate level, e.g., level 504, may store geographic coordinate ranges defining States, such as California, Oreg., indexing the states to the indices of the cities within the States. Further, another intermediate level (not shown) above intermediate level 504 may store geographic coordinate ranges representing Countries, such as United States, Canada, indexing the Countries to the indices of the States or Provinces within the Countries. Still further, yet another intermediate level, such as intermediate level 502 may store geographic coordinate ranges representing Continents, such as North America, Europe and so forth, indexing the Continents to the indices of the Countries.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing geographic coordinate ranges defining any geographic, political, cultural, social, and/or economic organizations.

While for thoroughness, the present disclosure has been described thus far with the lowest level of geographic coordinates based indices indexing Earth positions to associated contents, in embodiments, the “lowest” level of geographic coordinates based indices may be indices of geographic coordinate ranges indexing areas and/or regions instead.

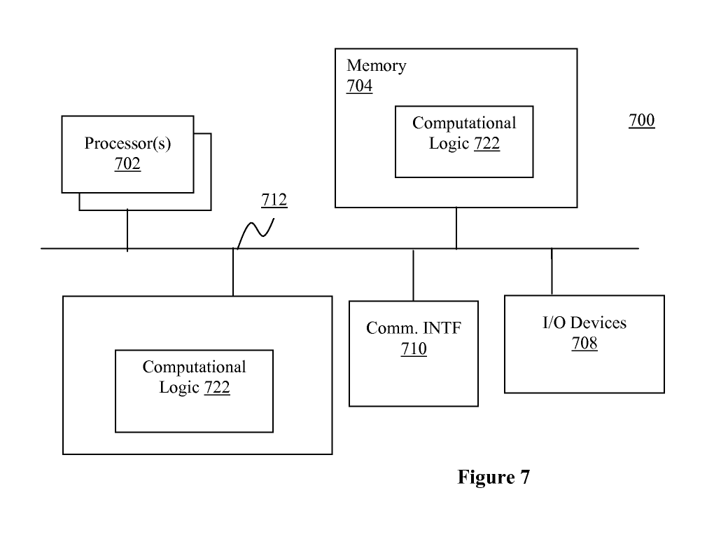

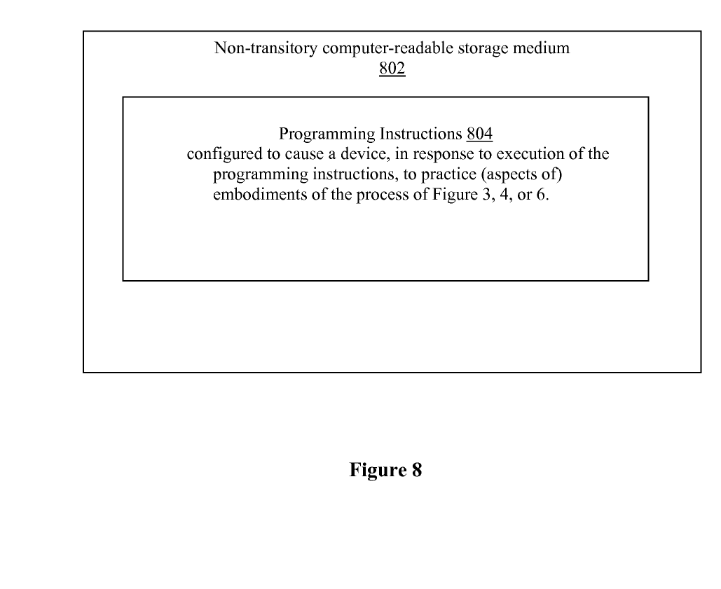

Referring now to FIG. 7, wherein an example computer suitable for use as client device 100 or 110, search module 108, or event repository 106 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with the client device 100, search module 108, event repository 106, reporting engine 102, crawler 104, subscription engine 130, or client device 110, collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as a client device 100 or 110, search module 108, event repository 106, reporting engine 102, subscription engine 130, or crawler 104. Further, the number, capability and/or capacity of these elements 710-712 may vary depending on, when computer 700 is used as client device 100 or 110, whether client device 100 or 110 is a stationary or mobile device, like a smartphone, computing tablet, ultrabook or laptop, with general or specific applications. The constitutions of these elements are otherwise known, and accordingly will not be further described.

FIG. 8 illustrates an example non-transitory computer-readable storage medium having instructions configured to practice all or selected ones of the operations associated with client device 100 or 110, search module 108, event repository 106, reporting engine 102, subscription engine 130, and/or crawler 104, earlier described; in accordance with various embodiments. As illustrated, non-transitory computer-readable storage medium 802 may include a number of programming instructions 804. Programming instructions 804 may be configured to enable a device in response to execution of the programming instructions, to perform various ones of the earlier described operations, e.g., various operations of processes 300, 400, or 600. In alternate embodiments, programming instructions 804 may be disposed on multiple non-transitory computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer readable storage medium comprising instructions configured to cause a computing device, upon execution of the instructions by the computing device, to:
receive, from a client device, a query that includes a time coordinate or a range of time coordinates that includes a point in time, and the query further includes a location identifier of a location or of an area including the location;
access an event repository to identify, based at least in part on the time coordinate or coordinates and the location identifier, one or more events at the location and at the point in time; and
transmit information about the one or more events to the client device.

2. The computer readable storage medium of claim 1, wherein the location identifier is an address of the location, or a name of an area including the location.

3. The computer readable storage medium of claim 1, wherein the one or more events stored in the event repository are indexed based at least in part on latitude and longitude coordinates of respective locations or areas of the one or more events, and wherein access comprises access the event repository based at least in part on a latitude coordinate and a longitude coordinate of the location.

4. The computer readable storage medium of claim 1, wherein the range of time coordinates includes a start time of a time period and an end time of the time period.

5. The computer readable storage medium of claim 1, wherein the point in time is a point in time in the past.

6. The computer readable storage medium of claim 1, wherein the information is information from a static document.

7. The computer readable storage medium of claim 6, wherein the static document is a newspaper, an internet website, a police report, or a fire report.

8. The computer readable storage medium of claim 1, wherein the client device is a first client device and the information is received from a second client device.

9. The computer readable storage medium of claim 8, wherein the second client device was at the location or is at the location when the information is received from the second client device.

10. An apparatus comprising:
a receive module configured to receive, from a client device, a query that includes a time coordinate or a range of time coordinates that includes a point in time, and the query further includes a location identifier of a location or of an area including the location;
an search module coupled with the receive module and configured to identify an event in an event repository based at least in part on the time coordinate or coordinates and the location identifier; and
a transmit module coupled with the search module and configured to transmit, in response to the query, information about the event to the client device.

11. The apparatus of claim 10, wherein the location identifier is an address of the location, or a name of an area including the location.

12. The apparatus of claim 10, wherein the event repository is configured to index one or more events based at least in part on latitude and longitude coordinates of respective locations of the one or more events, and the search module is configured to identify the event in the event repository based at least in part on a latitude coordinate and a longitude coordinate of the location.

13. The apparatus of claim 10, wherein the range of time coordinates includes a start time of a time period and an end time of the time period.

14. The apparatus of claim 10, wherein the point in time is a point in time in the past.

15. A method comprising:
transmitting, by a client device to an event repository, a query including a location identifier of a location or of an area including the location, and the query further including a time coordinate or a range of time coordinates that includes a point in time; and
receiving, by the client device from the event repository, a response to the query including information about an event at the location and at the point in time.

16. The method of claim 15, wherein the location identifier is an address of the location, an identifier of an area including the location, a latitude coordinate of the location, or a longitude coordinate of the location.

17. The method of claim 15, wherein the range of time coordinates includes a start time of a time period and an end time of the time period.

18. The method of claim 15, wherein the time is a time in the past.

19. A method comprising:
receiving, by an event module, information about an event, wherein the information includes information about what is the event, when did, is or will the event take place, and where did, is or will the event take place; and
storing, by the event module and based at least in part on the point in time or the location identifier, the information about the event in an event repository configured to store information of a plurality of events, wherein storing includes indexing the information for access by when and where the event takes place.

20. The method of claim 19, wherein receiving comprises receiving the information about the event from a client device, wherein the information about the event includes a description describing the event, a point in time indicating when the event took place, is taking place, or will take place, and a location identifier identifying a location or an area that includes a location denoting where the event took place, is taking place or will take place.

21. The method of claim 20, wherein receiving comprises receiving from the client device in real time while the client device is at the location.

22. The method of claim 19, wherein receiving the information about the event comprises first receiving a first report from a client device that includes at least a description describing the event, and second receiving a second report from the client device or a third party that includes at least a selected one of a point in time indicating when the event took place, is taking place, or will take place, and a location identifier identifying a location or an area that includes a location denoting where the event took place, is taking place or will take place.

23. The method of claim 22, wherein the second receiving from a third party comprises receiving a report from a carrier service that includes at least a selected one of the point in time or the location identifier.

24. The method of claim 19, wherein receiving the information about the event comprises a description describing the event, a point in time indicating when the event took place, is taking place, or will take place, and a location identifier identifying a location or an area that includes a location denoting where the event took place, is taking place or will take place from one or more static documents.

25. The method of claim 24, wherein the one or more static documents comprises a newspaper, an internet webpage, a permitting report, a licensing report, an inspection report, a police report, or a fire report.

26. The method of claim 19, wherein the location identifier includes an address of the event, a name of an area of the event, a latitude coordinate of the event, or a longitude coordinate of the event.

27. The method of claim 19, wherein receiving includes receiving the information about the event pushed to the event module from one or more subscription services without a request from the event module, wherein the information about the event includes a description describing the event, a point in time indicating when the event took place, is taking place, or will take place, and a location identifier identifying a location or an area that includes a location denoting where the event took place, is taking place or will take place.

28. The method of claim 27, wherein the one or more subscription services include one or more subscription services offered by internet news websites, messaging services, social networking websites, local, national, or international news organizations, or emergency response services.

29. The method of claim 19, wherein the storing the information about the event includes identifying, by the event module and based at least in part on the information about the event, that a relevance level of the event is above a threshold.

30. An apparatus comprising:
an event repository configured to store information of a plurality of events, wherein the information of the plurality of events is indexed in the event repository for access by when and where each event in the plurality of events takes place; and
an event module configured to:
receive information about an event, wherein the information includes information about what is the event, when did, is or will the event take place, and where did, is or will the event take place; and
store, based at least in part on the point in time or the location identifier, the information about the event in the event repository.

31. The apparatus of claim 30, wherein the event module is further configured to receive the information about the event from a client device that includes a description describing the event, a point in time indicating when the event took place, is taking place, or will take place, and a location identifier identifying a location or an area that includes a location denoting where the event took place, is taking place or will take place.

32. The apparatus of claim 31, wherein the event module is further configured to receive from the client device in real time while the client device is at the location.

33. The apparatus of claim 30, wherein the event module is further configured to first receive a first report from a client device that includes at least a description describing the event, and second receive a second report from the client device or a third party that includes at least a selected one of a point in time indicating when the event took place, is taking place, or will take place, and a location identifier identifying a location or an area that includes a location denoting where the event took place, is taking place or will take place, and identify the information about the event from the first report and the second report.

34. The apparatus of claim 33, wherein the client device is further configured to the third party is a carrier service and the event module is further configured to receive a third report from the carrier service that includes at least a selected one of the point in time or the location identifier.

35. The apparatus of claim 30, wherein the event module is further configured to extract t a description describing the event, a point in time indicating when the event took place, is taking place, or will take place, and a location identifier identifying a location or an area that includes a location denoting where the event took place, is taking place or will take place from one or more static documents to receive the information about the event.

36. The apparatus of claim 35, wherein the one or more static documents comprises a newspaper, an internet webpage, a permitting report, a licensing report, an inspection report, a police report, or a fire report.

37. The apparatus of claim 30, wherein the location identifier includes an address of the event, a name of an area of the event, a latitude coordinate of the event, or a longitude coordinate of the event.

38. The apparatus of claim 30, wherein the event module is further configured to receive the information about the event pushed to the event module from one or more subscription services without a request from the event module, wherein the information about the event includes a description describing the event, a point in time indicating when the event took place, is taking place, or will take place, and a location identifier identifying a location or an area that includes a location denoting where the event took place, is taking place or will take place.

39. The apparatus of claim 38, wherein the one or more subscription services include one or more subscription services offered by internet news websites, messaging services, social networking services, local, national, or international news organizations, or emergency response services.

40. The apparatus of claim 38, wherein the event module is further configured to identify, based at least in part on the information about the event, that a relevance level of the event is above a threshold; and
store the information about the event based at least in part on the relevance level of the event.

41. The apparatus of claim 38, wherein the event repository is further configured to identify, based at least in part on the information about the event, that a relevance level of the event is below a threshold; and
discard the information about the event from the event repository.

42. One or more computer readable media comprising instructions configured to cause a computing device, upon execution of the instructions by the computing device, to:
report, to an event repository, information about an event; and
report, to an event repository, at least a select one of a point of time of the event or a location identifier of the event, the location identifier identifies a location or an area that includes the location;
wherein the event repository is configured to store information related to a plurality of events and enable the stored information to be accessed based at least in part on respective times and locations of the plurality of the events.

43. The one or more computer readable media of claim 42, wherein the computing device is caused to report while the computing device is at the location.

44. The one or more computer readable media of claim 42, wherein the computing device is caused to report at the point in time of the event.

45. The one or more computer readable media of claim 42, wherein the location identifier is an address of the event, a name of an area of the event, a latitude coordinate of the event, or a longitude coordinate of the event.
